(19) United States
(12) Patent Application Publication
(10) Pub. No.: US 2015/0232264 A1
(43) Pub. Date: Aug. 20, 2015

(54) GLAND RETAINING CLIP FOR INTERMEDIATE BULK CONTAINERS

(71) Applicant: Bester Jacobus Pansegrouw, Ottery (ZA)

(72) Inventor: Bester Jacobus Pansegrouw, Ottery (ZA)

(73) Assignee: VORTEX INNOVATION WORX (PTY) LTD, Ottery (ZA)

(21) Appl. No.: 14/411,408

(22) PCT Filed: Jul. 2, 2012
(86) PCT No.: PCT/IB2012/053354

§ 371 Date: Apr. 16, 2015

(51) Int. Cl. B65D 88/16; F16B 2/22; B65D 77/06

(52) U.S. Cl. CPC B65D 88/1612; B65D 77/061; B65D 77/065; F16B 2/22; B65D 2577/041

(57) ABSTRACT

The invention discloses a gland retaining clip for intermediate bulk containers supporting flexible collapsible container inner bags used for the bulk handling of fluent materials, which includes a first supporting member and a second supporting member adapted to be assembled together to embrace a gland and adapted to be inserted into an outlet opening of an intermediate bulk container to fix the gland in this position; a clipping mechanism associated with either or both the first supporting member and the second supporting member and being adapted to clip the assembled first supporting member and the second supporting member to the outlet opening; and at least one alignment means located on either or both supporting members and adapted to align the assembled first supporting member and the second supporting member in relation to the outlet opening.

### FIELD OF INVENTION

The present invention relates to a gland retaining clip for intermediate bulk containers.

More particularly, the present invention relates to a gland retaining clip for intermediate bulk containers supporting flexible collapsible container inner bags used for the bulk handling of fluent materials.

### BACKGROUND TO INVENTION

Palletized transport or shipping containers are used for the bulk handling of fluent materials. In these palletized shipping containers a collapsible bag encased in a strong outer shell for bulk handling of liquids, fine powders, granular products and other goods having flow characteristics is provided in the shipping or transport container.

Intermediate bulk containers (IBC) have found wide acceptance for the shipment of goods. The intermediate bulk containers (IBC) consist of a 275 gallon container mounted to a skid or pallet. A wire mesh cage is also mounted to the skid and surrounds the container on all four sides. The top of the container is generally exposed. Additional pallets or intermediate bulk containers can accordingly be stacked for shipping and storage. A flexible collapsible inner bag actually contains the material and a rigid box-like structure that forms a secondary container houses the flexible bag. These “bag-in-a-box” type of transport containers generally include valve and spout or gland assemblies that are attached to the inner bag.

The intermediate bulk container is filled at the top by removing a cover providing access to an opening. A spout or gland located at the bottom acts as an outlet for goods stored in the container. A bulk container valve is typically removably secured to the intermediate bulk container to control removal of goods from the container. Often the valve is threaded onto the spout or gland and a hose can also then be connected to the valve to empty the contents of the IBC. This is time-consuming and laborious.

In addition the known gland or spout retaining clips for flexible collapsible container inner bags for use in an intermediate bulk container do not lock securely into all required intermediate bulk containers. This is attributed to the problem of wide variances in geometry critical to the gland retaining clip interface.

In addition the known gland or spout retaining clips for flexible collapsible container inner bags for use in an intermediate bulk container are cumbersome to be assembled and aligned.

It is an object of the invention to suggest a gland retaining clip for intermediate bulk containers which will assist in overcoming the aforementioned problems.

### SUMMARY OF INVENTION

According to the invention, a gland retaining clip for intermediate bulk containers supporting flexible collapsible container inner bags used for the bulk handling of fluent materials, includes
(a) a first supporting member and a second supporting member adapted to be assembled together to embrace a gland and adapted to be inserted into an outlet opening of an intermediate bulk container to fix the gland in this position;
(b) a clipping mechanism associated with either or both the first supporting member and the second supporting member and being adapted to clip the assembled first supporting member and the second supporting member to the outlet opening; and
(c) at least one alignment means located on either or both supporting members and adapted to align the assembled first supporting member and the second supporting member in relation to the outlet opening.

Also according to the invention, an intermediate bulk container, includes a gland retaining clip including
(a) a first supporting member and a second supporting member adapted to be assembled to embrace a gland and adapted to be inserted into an outlet opening of an intermediate bulk container to fix the gland in this position;
(b) a clipping mechanism associated with either or both the first supporting member and the second supporting member and being adapted to clip the assembled first supporting member and the second supporting member to the outlet opening; and
(c) at least one alignment means located on either or both supporting members and adapted to align the assembled first supporting member and the second supporting member in relation to the outlet opening.

Yet further according to the invention, a method for installing a gland retaining clip, includes the steps
(a) of assembling together a first supporting member and a second supporting member adapted to embrace a gland;
(b) of locating the gland embracing assembled first supporting member and a second supporting member into an outlet opening of an intermediate bulk container by means of a clipping mechanism to fix the gland in this position;
(c) of aligning in relation to the outlet opening, the gland embracing assembled first supporting member and a second supporting member by means of at least one alignment means.

Yet further according to the invention, a method for installing a gland retaining clip, includes the steps
(a) of assembling together a first supporting member and a second supporting member to embrace a gland by means of assembly means including a protruding member adapted to slide into an associated sliding guide member; and
(b) of locating the around a gland assembled first supporting member and a second supporting member into an outlet opening of an intermediate bulk container by means of a clipping mechanism to fix the gland in this position.

The first supporting member and the second supporting member may be substantially identical.

The alignment means may include at least one alignment wing and/or alignment tab.

The alignment means may consists of a pair of alignment wings and/or alignment tabs located on either side of each clipping mechanism.

The alignment means may include upstanding alignment wings.

The gland retaining clip may include abutment means adapted to ensure a snugly fit of the gland retaining clip in the outlet opening where the outlet opening is smaller than the gland retaining clip

The first supporting member and the second supporting members may be provided with assembly means adapted to enable the first supporting member and the second supporting member to be assembled.

The assembly means may include sliding guide legs.

The alignment means may be located on the edge opposite to the assembly means.

The gland retaining clip may be adapted to fit snugly in all intermediate bulk container openings having differing size variants.

The gland may have an internal diameter of about 2 to 4 inches.

The gland retaining clip may be made of plastics and/or be injection moulded.

The first supporting member and the second supporting member and its parts may respectively be integrally formed.

The intermediate bulk container may have a capacity of 50 to 500 gallons or about 189 to 2000 litres.

The invention also extends to a method for delivering bulk material as described herein.

### BRIEF DESCRIPTION OF DRAWINGS

The invention will now be described by way of example with reference to the accompanying schematic drawings.

In the drawings there is shown in:

FIG. 1: A first top perspective view of a supporting member of a gland retaining clip according to the invention;

FIG. 2: A second top perspective view of the supporting member as seen from arrow II in FIG. 1;

FIG. 3: A first bottom perspective view of the supporting member as seen from arrow III in FIG. 1;

FIG. 4: A second bottom perspective view of the supporting member as seen from arrow IV in FIG. 1;

FIG. 5: A top view of the supporting member as seen from arrow V in FIG. 1;

FIG. 6: A bottom view of the supporting member as seen from arrow VI in FIG. 1;

FIG. 7: A first side view of the supporting member as seen from arrow VII in FIG. 5;

FIG. 8: A second side view of the supporting member as seen from arrow VIII in FIG. 5;

FIG. 9: A third side view of the supporting member as seen from arrow IX in FIG. 5;

FIG. 10: A fourth side view of the supporting member as seen from arrow X in FIG. 5;

FIG. 11: A top perspective view of the gland retaining clip according to the invention incorporating two supporting members as shown in FIG. 1 being clipped together;

FIG. 12: A bottom view of the gland retaining clip as seen from FIG. XII in FIG. 11;

FIG. 13: An exploded view of the gland retaining clip shown in FIG. 11 showing a gland of an intermediate bulk container;

FIG. 14: A perspective view of the gland retaining clip shown in FIG. 13 surrounding the gland of the intermediate bulk container;

FIG. 15: A first image illustrating the method of installation of the gland retaining clip according to the invention;

FIG. 16: A second image illustrating the method of installation of the gland retaining clip according to the invention;

FIG. 17: A third image illustrating the method of installation of the gland retaining clip according to the invention;

FIG. 18: A fourth image illustrating the method of installation of the gland retaining clip according to the invention; and

FIG. 19: A fifth image illustrating the method of installation of the gland retaining clip according to the invention.

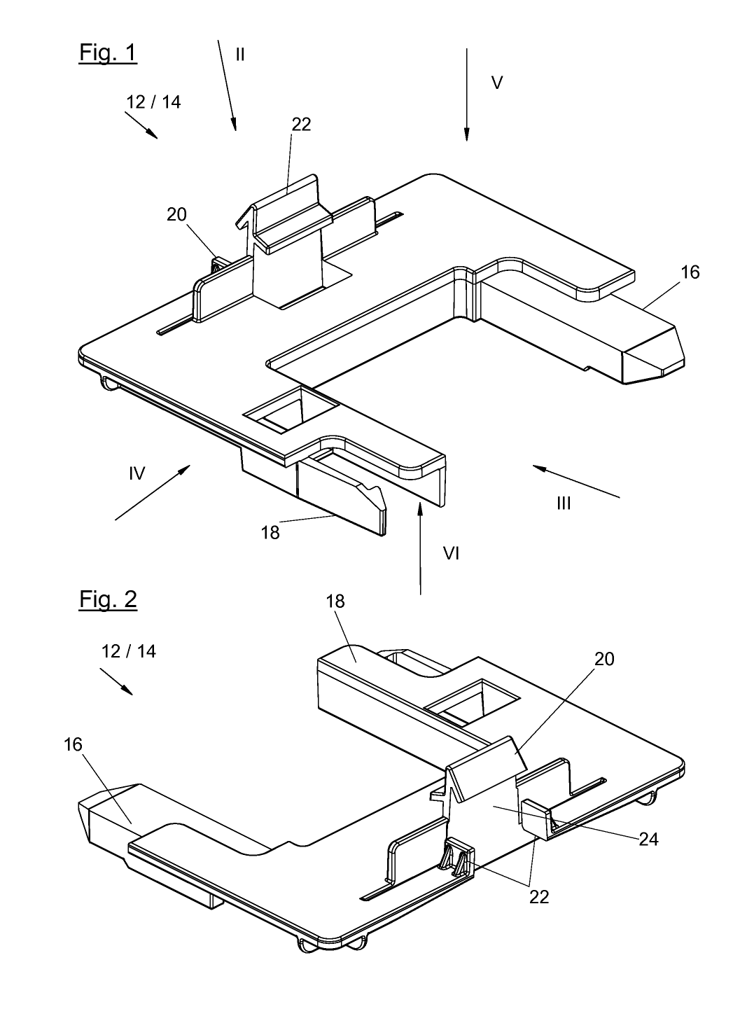

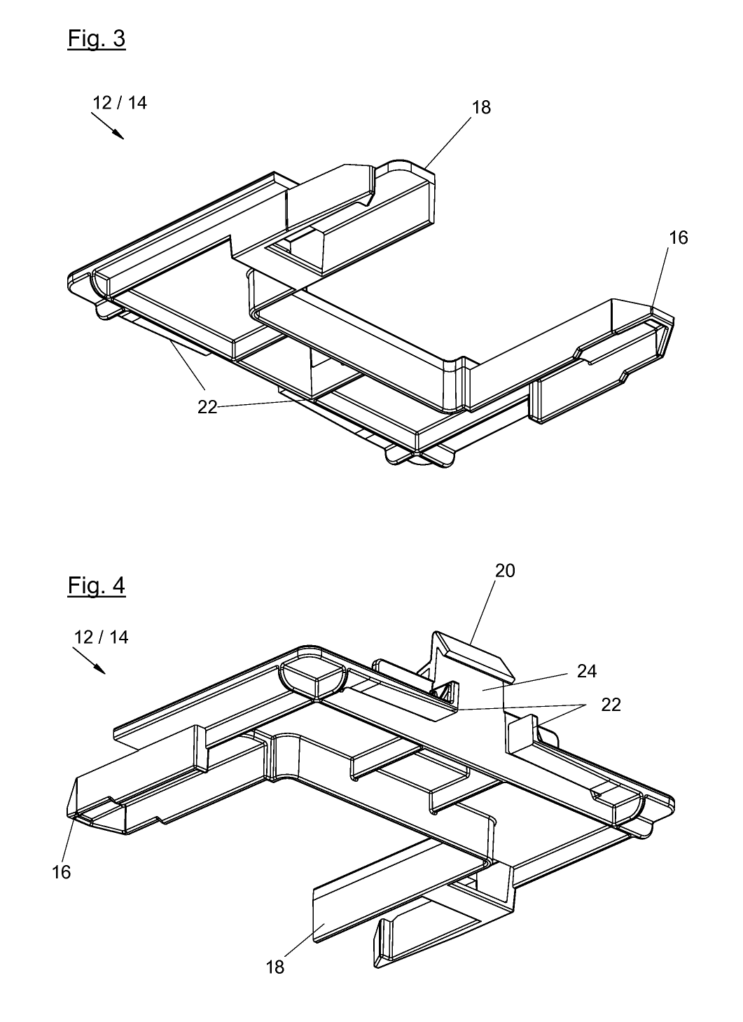

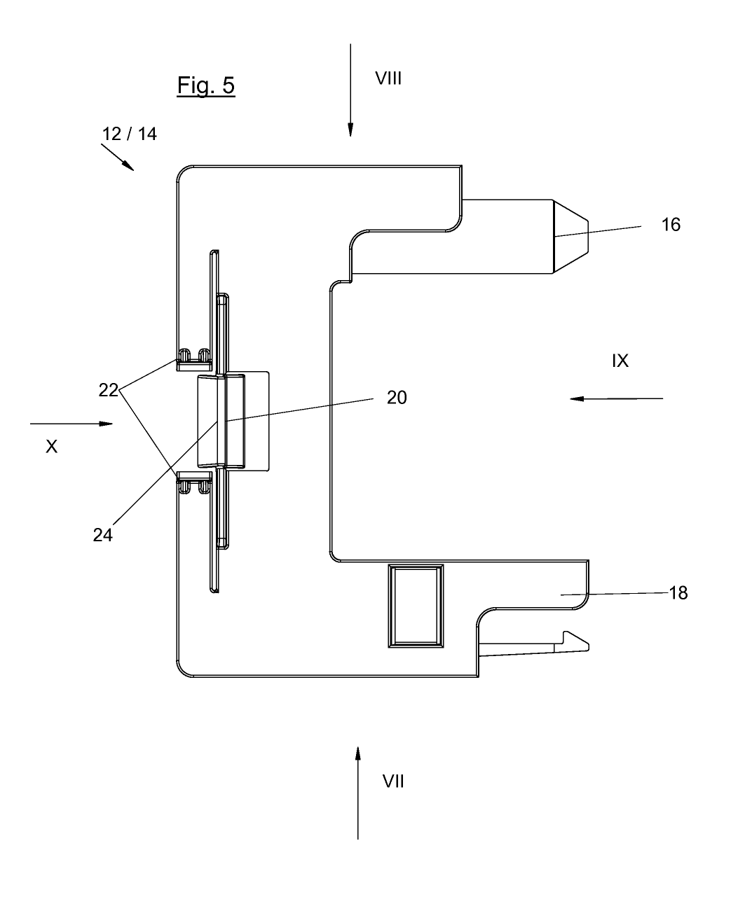

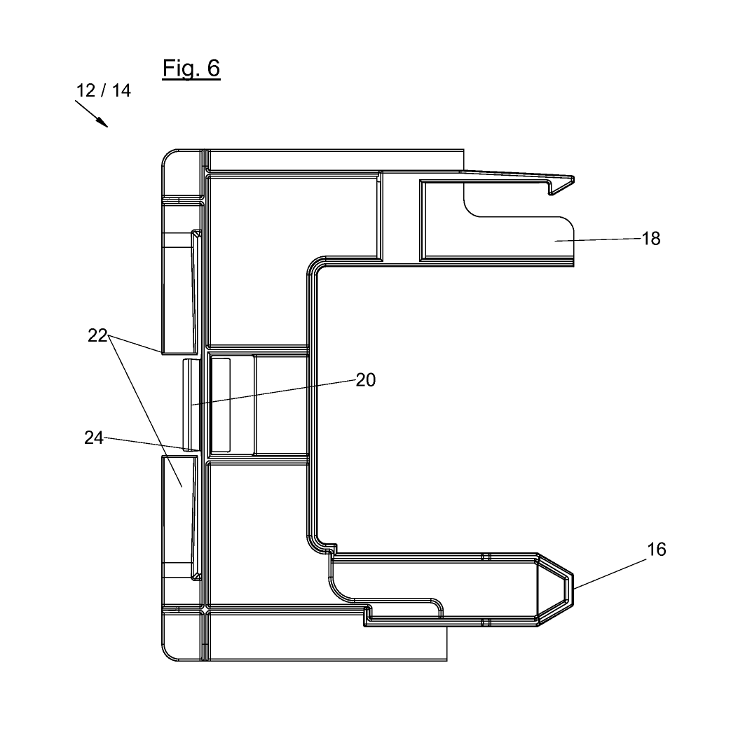

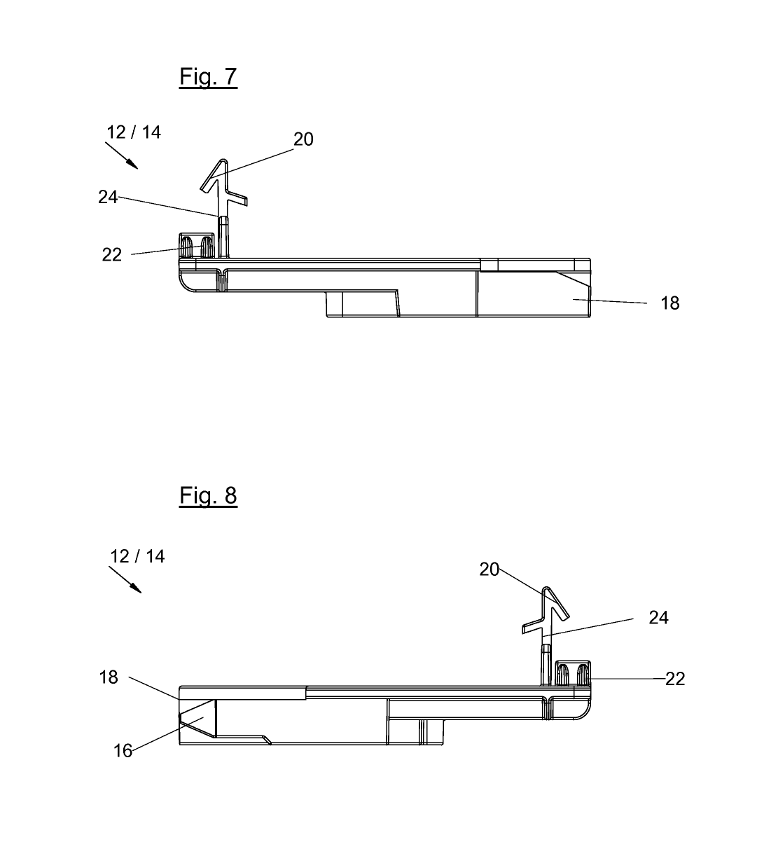

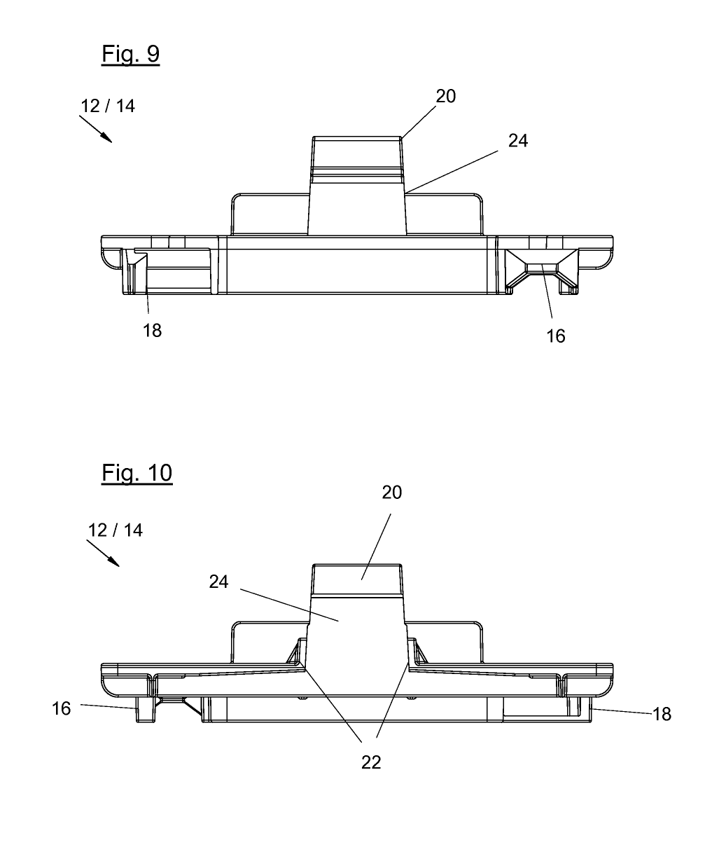

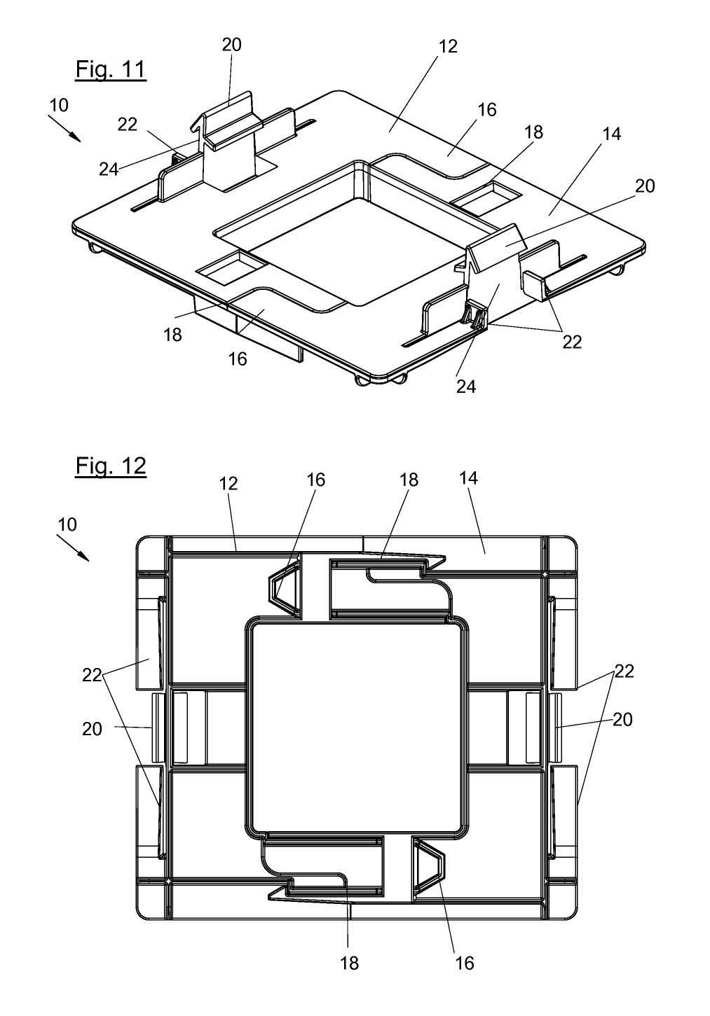

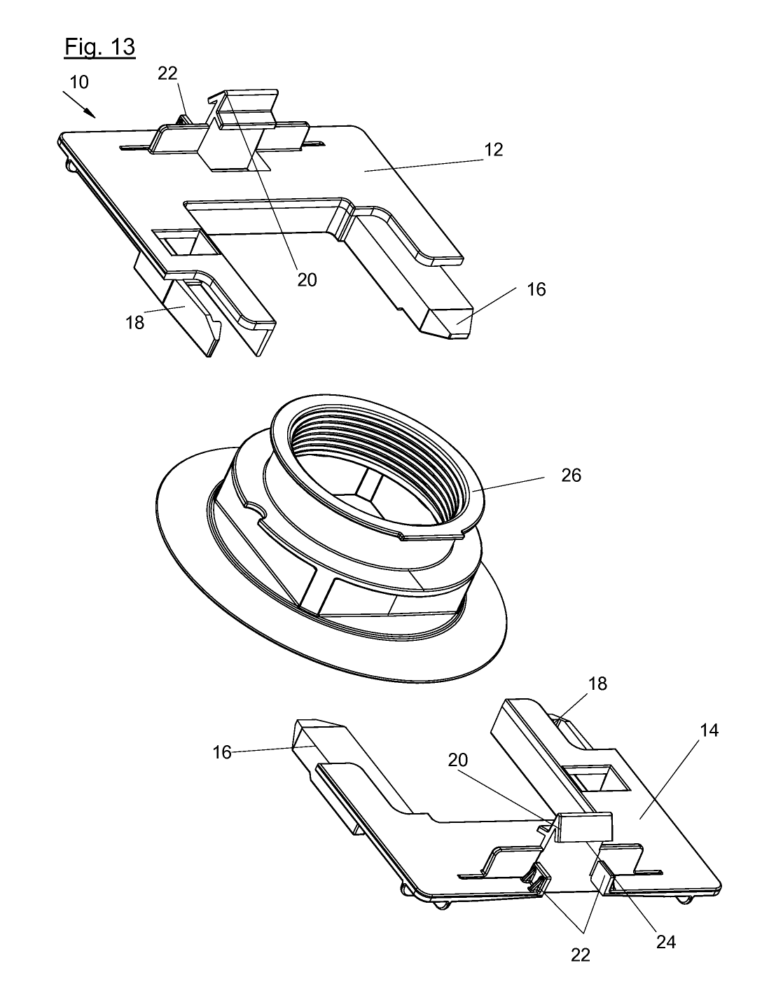

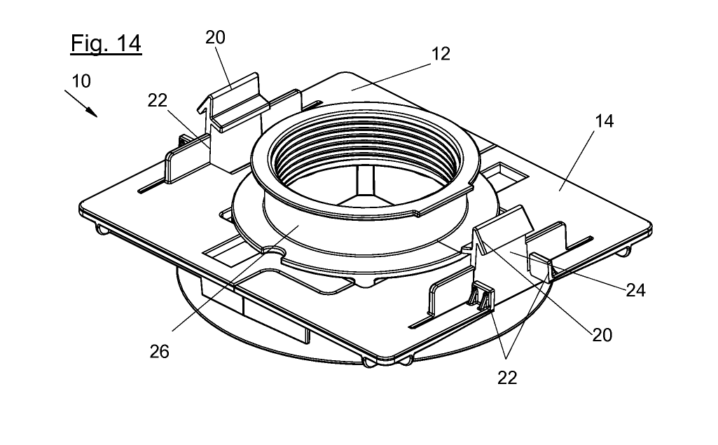

### DETAILED DESCRIPTION OF DRAWINGS

Referring to the Figures, a gland retaining clip for intermediate bulk containers in accordance with the invention, generally indicated by reference numeral 10, is shown.

The gland retaining clip 10 for intermediate bulk containers supporting flexible collapsible container inner bags used for the bulk handling of fluent materials, includes
(a) a first supporting member 12 and a second supporting member 14 adapted to be assembled together around a gland (or spout) 26 and into an outlet opening 28 of an intermediate bulk container to prevent the gland 26 from moving out of this position or from rotating;
(b) assembly means 16 and 18 provided on both the first supporting member 12 and a second supporting member 14 to assist in the assembling and clipping together of the first supporting member 12 and a second supporting member 14, the assembly means 16 and 18 define a protruding member 16 adapted to slide into a sliding guide member 18;
(c) a clipping mechanism 20 located on both the first supporting member 12 and the second supporting member 14 and being adapted to clip the assembled first supporting member 12 and the second supporting member 14 to locking member 30 of the outlet opening 28; and
(c) alignment means 22 and abutting means 24 located on both the first supporting member and the second supporting member and adapted to align the assembled first supporting member and the second supporting member in relation to the outlet opening 28.

The first supporting member 12 and the second supporting member 14 are identical.

The alignment means 22 includes two alignment wings or pair of tabs located on either side of the clipping mechanism 20. The alignment wings or pair of tabs can be upstanding alignment wings.

The protruding member 16 adapted to slide into a sliding guide member 18 ensures that the first supporting member 12 and a second supporting member 14 are assembled easily and correctly. With known gland retaining clips the supporting members slip as there are no guiding means. Thereby the assembly means 16 and 18 ensure that the first supporting member 12 and a second supporting member 14 are aligned correctly to ensure that they are assembled easily, snugly and quickly.

The clipping mechanism 20 and the alignment means 22 are located on the edge of the first supporting member 12 and a second supporting member 14 opposite to the assembly means 16 and 18.

The first supporting member 12 and a second supporting member 14 and its components are respectively integrally formed, made of plastics material and injection moulded.

The gland retaining clip 10 in accordance with the invention thus is adapted to be easily, quickly and snugly assembled and is adapted to fit snugly and ensure alignment in all intermediate bulk container openings having differing size variants. The gland retaining clip 10 (generally 2″) comprises two identical parts that are clipped together around a gland and into the outlet opening of an intermediate bulk container to prevent the gland from moving out of this position or from rotating when decanting tools are fitted or removed from the gland. Accordingly the gland retaining clip interfaces effectively with all required intermediate bulk containers (IBC).

The flexible collapsible bags of the intermediate bulk containers are made of plastics material, such as polyester.

Generally the intermediate bulk container has a capacity of 50 to 500 gallons (or about 189 to 2000 litres).

Thus the flexible collapsible bag in accordance with the invention provides for a method for a quick and labour-saving method for locating a flexible collapsible container into an intermediate bulk container and for locking the outlet means of the flexible collapsible container to the outlet of the intermediate bulk container.

### Example

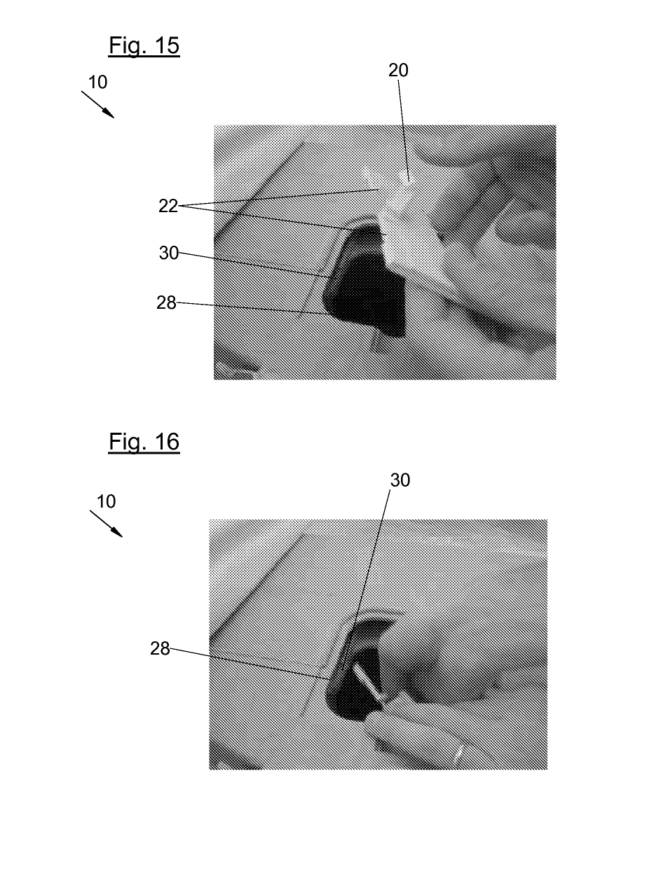

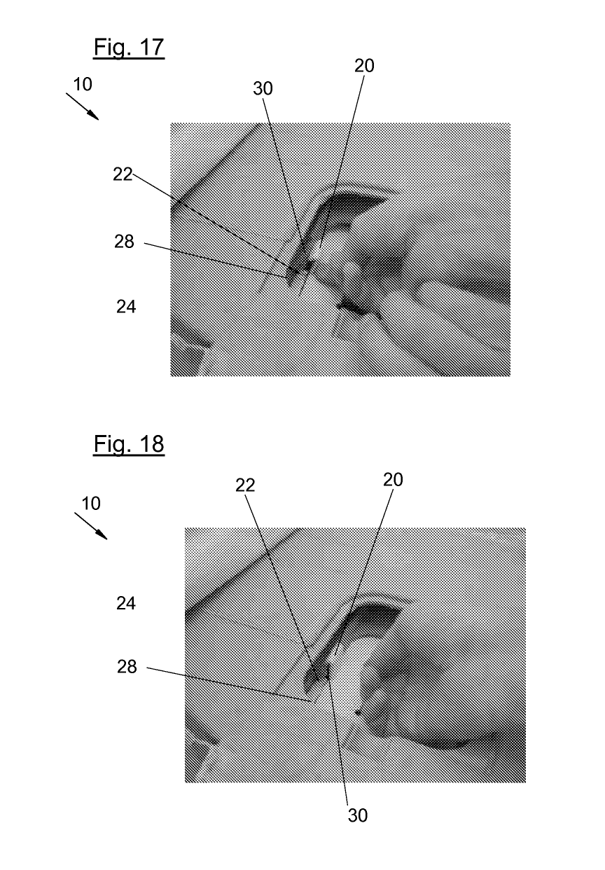

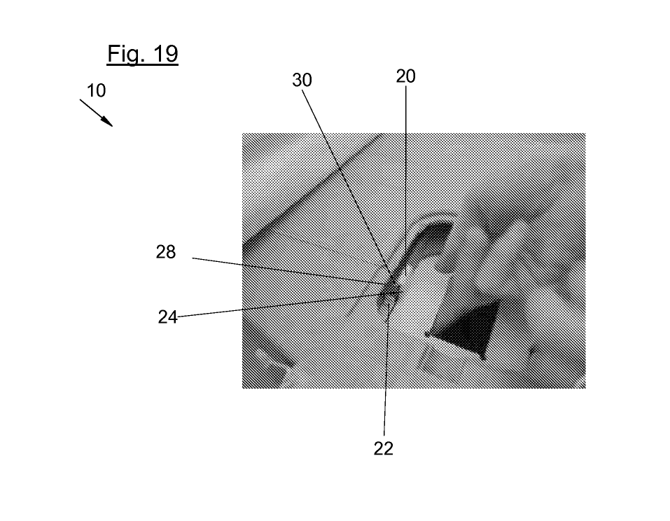

Referring to FIGS. 15 to 19, various images illustrating the method of installation of the gland retaining clip according to the invention are shown. The 2″ gland retaining clip in accordance with the invention is installed by trained personnel as follows:
(a) Two 2″ gland retaining clip parts (the first supporting member 12 and the second supporting member 14) are clipped and assembled together around a gland 26 at a production facility;
(b) The assembly gland, bag and gland retaining clip is dropped into an Intermediate bulk container by a distributor;
(c) The gland retaining clip 10 is clipped into the outlet opening 28 of the intermediate bulk container by a distributor, either by pushing it into the opening from the inside of the intermediate bulk container or by pulling it into the opening from the outside of the intermediate bulk container. The clipping mechanism 22 locking with the locking member 30 of the outlet opening 28 ensures that the gland retaining clip is clipped into position and prevents the gland retaining clip 10 and the gland 26 from moving out of this position or from rotating. The abutting means 24 ensures that the gland retaining clip 10 is kept in position where the locking member 30 of the outlet opening 28 is somewhat larger than normal whereas the alignment means 22 ensures that the gland retaining clip 10 is correctly positioned in the outlet opening 28 where the locking member 30 of outlet opening 28 is somewhat smaller—hence the alignment wings of the alignment means 22 stop against the locking member 30—accordingly the liner is kept in position (also no tools are used);
(d) The bag is filled after distribution (Some Intermediate bulk containers are collapsed for distribution); and
(e) Assembly of a tamper cap (red) may happen before or after distribution.

Removal: the 2″ gland retaining clip 10 is removed from the intermediate bulk container after the bag has been emptied. Kindly note that no tools are required.

Removal of the 2″ gland retaining clip from the gland/bag assembly is not required because none of these parts are reused.

1. A gland retaining clip for intermediate bulk containers supporting flexible collapsible container inner bags used for the bulk handling of fluent materials, said gland retaining clip comprising:
(a) a first supporting member and a second supporting member adapted to be assembled together to embrace a gland and adapted to be inserted into an outlet opening of an intermediate bulk container to fix the gland in this position;
(b) a clipping mechanism associated with either or both the first supporting member and the second supporting member and being adapted to clip the assembled first supporting member and the second supporting member to the outlet opening; and
(c) at least one alignment means located on either or both supporting members and adapted to align the assembled first supporting member and the second supporting member in relation to the outlet opening.

2. The gland retaining clip as claimed in claim 1, in which the first supporting member and the second supporting member are substantially identical.

3. The gland retaining clip as claimed in claim 1, in which the alignment means includes at least one alignment wing and/or alignment tab.

4. The gland retaining clip as claimed in claim 1, in which the alignment means consists of a pair of alignment wings and/or alignment tabs located on either side of each clipping mechanism.

5. The gland retaining clip as claimed in claim 1, in which the alignment means include upstanding alignment wings.

6. The gland retaining clip as claimed in claim 1, which includes abutment means adapted to ensure a snugly fit of the gland retaining clip in the outlet opening where the outlet opening is smaller than the gland retaining clip.

7. The gland retaining clip as claimed in claim 1, in which the first supporting member and the second supporting members are provided with assembly means adapted to enable the first supporting member and the second supporting member to be assembled.

8. The gland retaining clip as claimed in claim 6, in which the assembly means include sliding guide legs.

9. The gland retaining clip as claimed in claim 6, in which the alignment means are located on the edge opposite to the assembly means.

10. The gland retaining clip as claimed in claim 1, which is adapted to fit snugly in all intermediate bulk container openings having differing size variants.

11. The gland retaining clip as claimed in claim 1, in which the gland has an internal diameter of about 2 to 4 inches.

12. The gland retaining clip as claimed in claim 1, which is made of plastics and/or is injection moulded.

13. The gland retaining clip as claimed in claim 1, in which the first supporting member and the second supporting member and its parts are respectively integrally formed.

14. The gland retaining clip as claimed in claim 1, in which the intermediate bulk container has a capacity of 50 to 500 gallons or about 189 to 2000 litres.

15. An intermediate bulk container, which includes a gland retaining clip, said intermediate bulk container comprising:
(a) a first supporting member and a second supporting member adapted to be assembled to embrace a gland and adapted to be inserted into an outlet opening of an intermediate bulk container to fix the gland in this position;
(b) a clipping mechanism associated with both the first supporting member and the second supporting member and being adapted to clip the assembled first supporting member and the second supporting member to the outlet opening; and
(c) at least one alignment means located on either or both supporting members and adapted to align the assembled first supporting member and the second supporting member in relation to the outlet opening.

16. A method for installing a gland retaining clip, which includes the steps
(a) of assembling together a first supporting member and a second supporting member adapted to embrace a gland;
(b) of locating the gland embracing assembled first supporting member and a second supporting member into an outlet opening of an intermediate bulk container by means of a clipping mechanism to fix the gland in this position; and
(c) of aligning in relation to the outlet opening, the gland embracing assembled first supporting member and a second supporting member by means of at least one alignment means.

17-20. (canceled)
